(19) United States
(12) Patent Application Publication
(10) Pub. No.: US 2009/0234678 A1
(43) Pub. Date: Sep. 17, 2009

(54) COMPUTER SYSTEMS AND METHODS FOR ASSISTING ACCIDENT VICTIMS WITH INSURANCE CLAIMS

(75) Inventor: Robert F. Arenas, Temecula, CA (US)

Correspondence Address: KNOBBE MARTENS OLSON & BEAR LLP, 2040 MAIN STREET, FOURTEENTH FLOOR, IRVINE, CA, 92614, US

(73) Assignee: Arenas Claims Consulting, Inc., Murrieta, CA (US)

(21) Appl. No.: 12/401,537

(22) Filed: Mar. 10, 2009

Related U.S. Application Data
(60) Provisional application No. 61/035,475, filed on Mar. 11, 2008.

(51) Int. Cl. G06Q 40/00

(52) U.S. Cl. 705/4

(57) ABSTRACT

Systems and methods for assisting loss participants with insurance claims may provide functionality for loss participants to create reports about losses. Each loss report may include media such as text, images, and video that documents the loss. The systems and methods may provide functionality for users to electronically submit the loss report to other entities, such as an insurer, an adjuster, an attorney, friends or family, and the like. Adjusters may also create loss reports or may request reports from technicians who specialize in creating loss reports. By virtue of the systems and methods being related to loss reporting, the systems and methods may select loss-related ads for presentation to users. These ads may be further targeted to users based at least partly on the loss information provided by users. For instance, the ads can be for items that correspond to one or more effects of a user's loss.

### RELATED APPLICATION

This application claims the benefit of priority under 35 U.S.C. § 119(e) of U.S. Provisional Patent Application No. 61/035,475, filed on Mar. 11, 2008, and entitled “Systems and Methods of Reaching, Capturing, and Presenting Advertisements/Branding to Accident Victims,” the disclosure of which is hereby incorporated by reference in its entirety.

### BACKGROUND

Many municipalities are required by law to send police officers to vehicular accidents and other accidents that involve bodily injury and/or significant property damage. The officers who respond to such serious accidents file accident reports that become available to insurance carriers to use in determining where fault, if any, rests for the accident. These reports are typically hard copy reports, which the police mail to insurance carriers.

One drawback from this approach to accident reporting is that scarce resources normally preclude police from responding to accidents that fall below minimum reporting levels for the lack of apparent injuries or significant property damages. For this class of relatively minor accidents, professional and objective reports are rarely ever assembled from evidence taken at the time of the accident. Consequently, issues of liability and fraud can remain confused and contested and thereby greatly increase the costs of claims adjusting.

### SUMMARY OF CERTAIN INVENTIVE ASPECTS

In certain embodiments, systems and methods for assisting loss participants with insurance claims provide functionality for loss participants to create reports about losses. Each loss report may include media such as text, images, and video that documents the loss. The systems and methods may provide functionality for users to electronically submit the loss report to other entities, such as an insurer, an adjuster, an attorney, friends or family, and the like. Others may create loss reports as well. For example, adjusters can create loss reports or request reports from technicians who specialize in creating loss reports.

By virtue of the systems and methods being related to loss reporting, the systems and methods may select loss-related ads for presentation to users. These ads may be further targeted to users based at least partly on the loss information provided by users. For instance, the ads can be for items (for example, goods or services) that correspond to one or more effects of a user's loss.

Example implementations of a loss reporting system might include a loss report module that can output a loss report interface for presentation to a user. The loss report interface may be able to provide functionality for the user to prepare a loss report by inputting loss data corresponding to a loss. In addition, the loss reporting system may include a training module that can electronically provide instructions for preparing the loss report to the user, such that the loss report includes information relevant to an insurance claim. Moreover, the loss reporting system might include an advertising module that can execute in one or more processors to use loss information to obtain an advertisement targeted to the user. The advertisement can be for an item that corresponds to one or more effects of the loss.

In various embodiments, a processor-implemented method of advertising insurance may include providing a loss-reporting network application having a loss report interface that can provide functionality for a user to create a loss report by inputting data corresponding to a loss. The loss data may include one or more of at least one image, at least one video, and text. The method may also include receiving an indication of a type of the loss and using one or more processors to select an advertisement based at least partly on the type of the loss. The advertisement may have a logo of an insurer that provides insurance for the loss type. In addition, the method can include automatically embedding the advertisement in the loss data.

In certain implementations, a computer-readable storage medium is provided that has instructions stored thereon that cause one or more processors to perform a method of offering targeted advertisements in connection with a loss report. The method may include outputting one or more loss report interfaces using a network application for presentation to a user, where the one or more loss report interfaces can provide functionality for the user to create a loss report by inputting data corresponding to a loss. The loss data may include one or more of at least one image, at least one video, and text. The method may also include providing functionality for the user to electronically submit the loss report to one or more entities, where the one or more entities include one or more of the following: a claim adjuster, an insurer, and an attorney. Further, the method may include obtaining a loss-related advertisement based at least partly on a loss-reporting attribute of the network application and on one or more of loss, user, and claim information mined from the loss data, such that the advertisement is for an item that corresponds to one or more effects of the loss.

Moreover, in various embodiments, a server system for offering targeted advertisements in connection with a loss report includes a loss reporting system having a loss report module and an advertising module. The loss report module may output a loss report interface for presentation to a user. The loss report interface can provide functionality for the user to create a loss report by inputting data corresponding to a loss, where the loss data includes one or more of at least one image, at least one video, and text. The loss report interface can also provide functionality for the user to electronically submit the loss report to one or more entities, where the one or more entities include one or more of the following: a claim adjuster, an insurer, and an attorney. The advertising module may execute in one or more processors and may include a loss data mining module that analyzes the loss data to determine one or more of a characteristic of the loss and a characteristic of the user and an advertisement selector that obtains a loss-related advertisement based at least partly on a loss-reporting attribute of the loss reporting system and on one or more of the loss characteristic and the user characteristic. As a result, in certain embodiments, the advertisement is for an item that corresponds to one or more effects of the loss.

For purposes of summarizing the disclosure, certain aspects, advantages and novel features of certain inventions have been described herein. It is to be understood that not necessarily all such advantages may be achieved in accordance with any particular embodiment of the inventions disclosed herein. Thus, the inventions disclosed herein may be embodied or carried out in a manner that achieves or optimizes one advantage or group of advantages as taught herein without necessarily achieving other advantages as may be taught or suggested herein.

### BRIEF DESCRIPTION OF THE DRAWINGS

Throughout the drawings, reference numbers may be re-used to indicate correspondence between referenced elements. The drawings are provided to illustrate embodiments of the inventions described herein and not to limit the scope thereof.

FIG. 1 illustrates an embodiment of a network environment for accessing a loss reporting system;

FIG. 2 illustrates an embodiment of an advertising module;

FIG. 3 illustrates an embodiment of a process for offering targeted advertisements in connection with a loss report;

FIG. 4 illustrates an embodiment of a process for embedding advertisements in a loss report;

FIGS. 5A through 8 illustrate example user interfaces for creating loss reports;

FIG. 9 illustrates an example loss report;

FIG. 10 illustrates an example user interface for training users to create loss reports; and

FIG. 11 illustrates an example template for training users to create loss reports.

### DETAILED DESCRIPTION

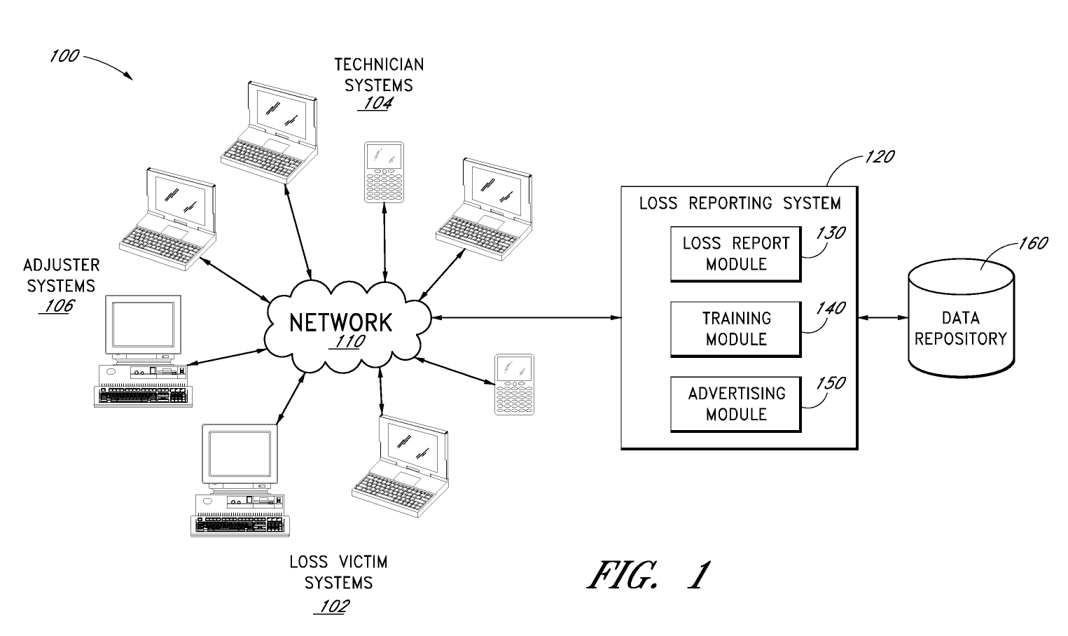

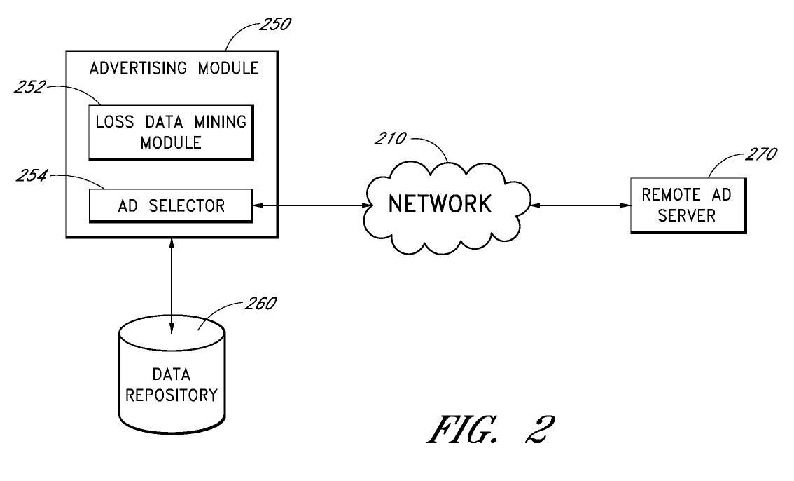

Turning now to the FIGURES, specific embodiments of the systems and methods for assisting loss participants with insurance claims will now be described. FIG. 1 depicts an embodiment of a loss reporting environment 100 for providing users with access to a loss reporting system 120. The loss reporting system 120 may be used by loss participants, claim adjusters, and others to document losses, such as accidents. The loss reporting system 120, in certain embodiments, advantageously targets advertisements to the loss participants, adjusters, and/or others based at least partly on loss information, among other things.

The loss reporting system 120 may be implemented by one or more physical computing devices having computer hardware, such as a server system. In certain embodiments, the loss reporting system 120 may be embodied in a plurality of server systems or other physical computing machines, each executing an instance of the loss reporting system 120. These server systems may be distributed geographically or may be co-located.

The loss reporting system 120 may provide one or more network applications such as web applications for access by various user systems 102,104, 106. The one or more network applications of the loss reporting system 120 can include a web site, one or more web pages, one or more content objects embedded in a page, and/or an application server, among other things. The user systems 102, 104, 106 may include various types of computing devices, such as, for example, desktop computers, workstations, web pads, personal digital assistants (PDAs), mobile phones, set-top television boxes, media players, laptop computers, tablets, combinations of the same and the like. The various types of user systems 102,104, 106 depicted in FIG. 1 will be described below.

The user systems 102, 104, 106 can further include various software applications for accessing the loss reporting system 120, such as browser software applications, stand-alone software applications, plug-ins, interfaces, combinations of the same, and the like. The user systems 102, 104, 106 may access the loss reporting system 120 over a network 110, which may include a local or wide area network (LAN or WAN), such as an organization's intranet, the Internet, combinations of the same, and the like.

In certain embodiments, the loss reporting system 120 provides the functionality for users to create and view loss reports. The loss reporting system 120 may, for example, provide one or more user interfaces for users to describe a loss. The loss may be an accident, such as a car accident, a slip and fall accident, or any other accident. The loss may also be a loss of property due to property theft or a loss resulting from any other crime or tort. The loss reporting system 120 may train users to create loss reports that include information relevant to an insurance claim. Additionally, the loss reporting system 120 may present advertisements to users while the users create and/or view loss reports.

Various types of users may access the loss reporting system 120. Example users depicted in FIG. 1 include loss participants, technicians, and adjusters. Loss participants, such as accident victims, may access the loss reporting system 122 via user systems 102 to create loss reports to assist with preparing an insurance claim or for compiling evidence for a lawsuit or alternative dispute resolution. Technicians may be employed by or have a contract with an operator of the loss reporting system 120. Technicians may conduct loss scene investigations upon request by loss participants, adjusters, or others. The technicians may use technician systems 104 to access the loss reporting system 120 to create loss reports.

Adjusters using systems 106 may also create and/or view loss reports with the loss reporting system 120. Other users, such as bystanders, employees of a company involved in a loss, and the like may use the loss reporting system 120. Each of these users may receive online training in the creation of loss reports and may receive targeted advertisements from the loss reporting system 120.

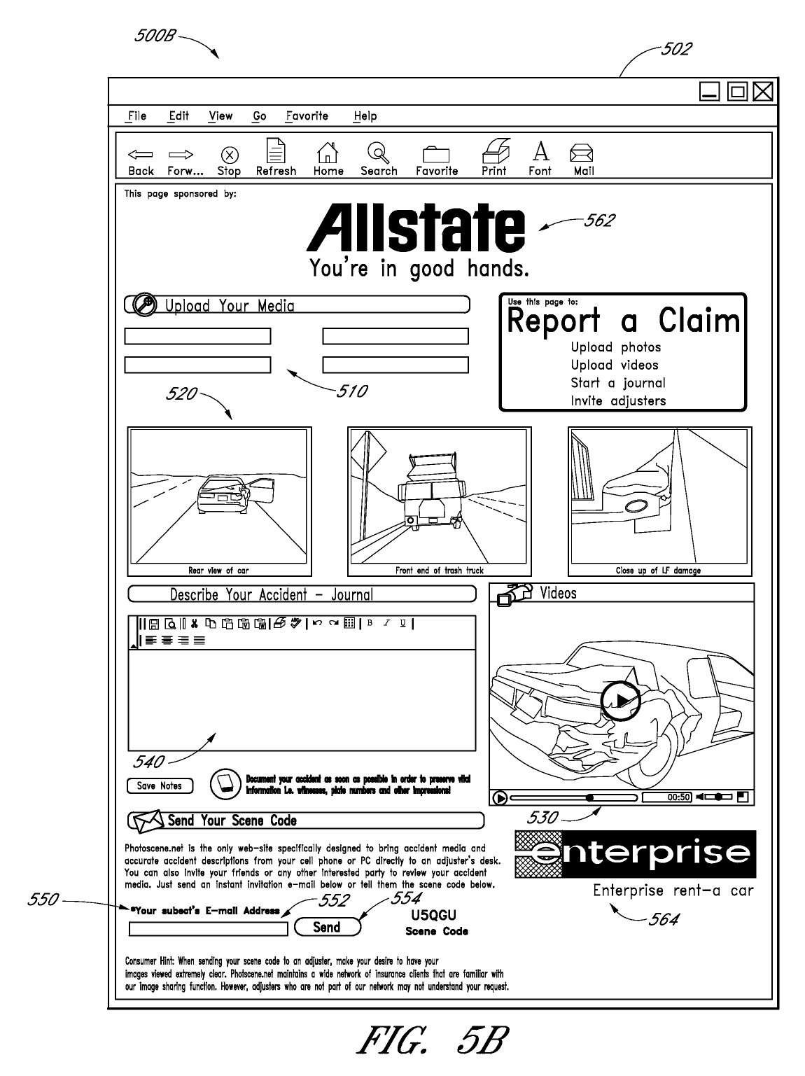

As shown, in the depicted embodiment, the loss reporting system 120 includes a loss report module 130, a training module 140, and an advertising module 150. The loss report module 130 may include hardware and/or software for generating loss reports, for outputting loss reports for presentation to users, and for sharing loss reports with other users, among other features. The loss report module 130 can allow users to create or upload text and media associated with a loss, including documents, images, audio, video, and the like. The loss report module 130 may also provide drawing tools to assist users in sketching loss scenes, such as intersections of vehicular accidents. The loss report module 130 may provide other tools as well, including traffic light timing and sequencing tools. Example user interfaces for creating loss reports are described below with respect to FIGS. 5A through 8.

The training module 140 of the loss reporting system 120 can include hardware and/or software for training users to create loss reports. Advantageously, in certain embodiments, the training module 140 may train users to create loss reports that have information relevant to an insurance claim, including information that claim adjusters might like to have when evaluating a claim. For example, the training module 140 may provide information on which types of photographs or video to take of a loss scene, from which angles to take the photographs or video, questions to ask people associated with the loss, and the like. The training module 140 may provide instructional videos, templates, checklists, and/or other instructional materials.

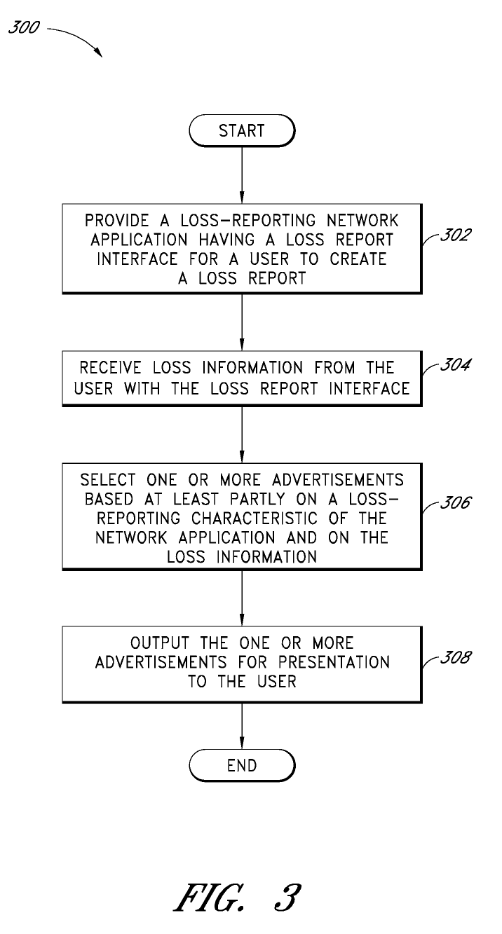

The advertising module 150 may include hardware and/or software for selecting targeted advertisements to output for presentation to a user. By virtue of the loss reporting system 120 being related to loss reporting, the advertising module 150 may select loss-related ads for presentation to users. These ads may be further targeted to users based at least partly on the loss information provided by users. Moreover, the ads can be for items that correspond to one or more effects of a user's loss (such as car rental services to address an auto accident). Thus, in certain embodiments, the advertising module 150 transforms user-provided data about a loss, which represents an actual physical event or condition, into electronic advertisements representing physical goods or services, which the advertising module 150 outputs for display to a user. Advertising examples are described below with respect to FIGS. 2 through 5B.

The loss reporting system 120 may communicate with a data repository 160. The data repository 160 may include one or more physical computer storage devices. The loss reporting system 120 may, for instance, store in a data repository 160 loss reports, user data including personal information about users, advertisements, and the like.

FIG. 2 illustrates a more detailed embodiment of an advertising module 250. The advertising module 250 may include all the features of the advertising module 150 described above. Advantageously, in certain embodiments, the advertising module 250 may present advertisements to users based at least partly on loss information.

The advertising module 250 in the depicted embodiment includes a loss data mining module 252 and an ad selector 254. Both the loss data mining module 252 and the ad selector 254 may include computer hardware and/or software. The loss data mining module 252 can mine the loss information from completed loss reports and from loss reports that are in progress. The ad selector 254 can use this mined information to select targeted advertisements for presentation to users who are viewing completed loss reports and to users who are creating loss reports.

The loss data mining module 252 can mine the loss information by analyzing the loss information to determine one or more of loss characteristics, user characteristics, and claim stage characteristics. The loss characteristics may include a type of a loss (e.g., an auto accident), the severity of the loss (e.g., as determined by extent of damage or injury, which may be indicated by a user), the location of the loss, combinations of the same, and the like. The user characteristics may include a type of the user who is preparing or viewing a loss report (e.g., loss participant, technician, adjuster, or other). The user characteristics can also include a geographic location of the user, such as a residence or business address. Thus, in certain embodiments, ads can be selected for goods and services provided by businesses located in close geographical proximity to a user. The loss data mining module 252 may obtain the user characteristics from profile data provided by the user.

The claim characteristics can include information on stages of a claim associated with the loss. These stages might include a pre-claim stage for loss reports not yet associated with a claim, a claim pending stage for loss reports associated with a claim, and a post-claim stage for loss reports associated with finished claims. Information on a stage of a claim may be submitted by the user who created the report, a user who modifies the report (e.g., an adjuster), or the like. For example, if a user has not submitted a claim number to the loss report, the loss data mining module 252 might determine that the report is in a pre-claim stage. Once the user uploads a claim number, the loss data mining module 252 might determine that the report is in a claim pending stage, and so forth.

In certain embodiments, the loss data mining module 252 obtains the loss, user, and/or claim characteristics from textual data entered into a loss report, from a user's selection of a user interface control such as a button, a drop down list, radio buttons, check box buttons, a text box, or the like. To illustrate, the loss report module 130 described above may present a drop down list of accident types for selection by a user. The accident types might include, for example, vehicular accident, slip and fall accident, workman's compensation accident, and the like.

The ad selector 254 can select one or more ads for presentation to a user. The ad selector 254 may select one or more loss-related ads by virtue of the loss reporting system 120 being related to losses. In addition, the ad selector 254 can target one or more ads to the user based at least partly on the loss, user, and/or claim characteristics obtained by the loss data mining module 252. The ad selector 254 can embed the one or more ads in a loss report creation interface or in a loss report.

In one embodiment, the ad selector 254 selects an ad from an ad repository 260 using one or more loss, user, and/or claim characteristics. The ad repository 260 may include data representing ads associated with loss, user, and/or claim characteristics. Thus, the data repository 260 might include, for example, stored associations between rental car ads and the loss characteristic of “loss type=auto accident.” As another example, the data repository 260 might include stored associations between insurance publication ads and the user characteristic of “user type=adjuster.”

Ads selected by the ad selector 254 based on the claims characteristic for a pre-claim stage might include ads for insurers, while ads for later stages might not advertise insurers as services for an insurer have already been requested. Ads displayed during a post-claim stage might be targeted to ways to spend the claim award, such as for new automobiles or the like. Various ads may be associated with one or more of these claim characteristics in the data repository 260.

In another embodiment, the ad selector 254 requests ads from a remote ad server 270. The remote ad server 270 may be operated by a different operator than the operator of the advertising module 250. The ad selector 254 may send selected loss, user, and/or claim characteristics to the remote ad server 270. The remote ad server 270 may in turn select ads based on the loss, user, and/or claim characteristics. For instance, the ad selector 254 can request ads related to auto accidents, where the target user for the ad is a victim of an auto accident. In response, the remote ad server at 270 may return automobile dealership ads, personal injury attorney ads, and the like to the ad selector 254.

FIG. 3 illustrates an embodiment of an ad selection process 300 for selecting targeted ads for presentation to a user. The ad selection process 300 may be implemented by the loss reporting system 120. Advantageously, in certain embodiments, the ad selection process 300 selects targeted ads for users creating and/or viewing loss reports.

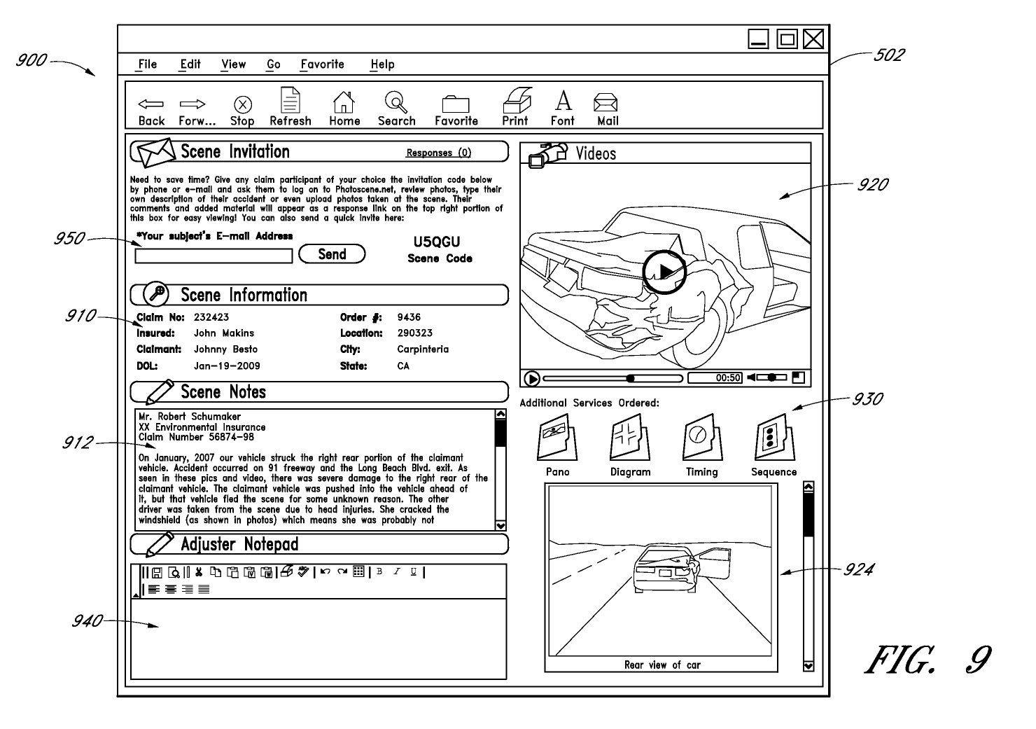

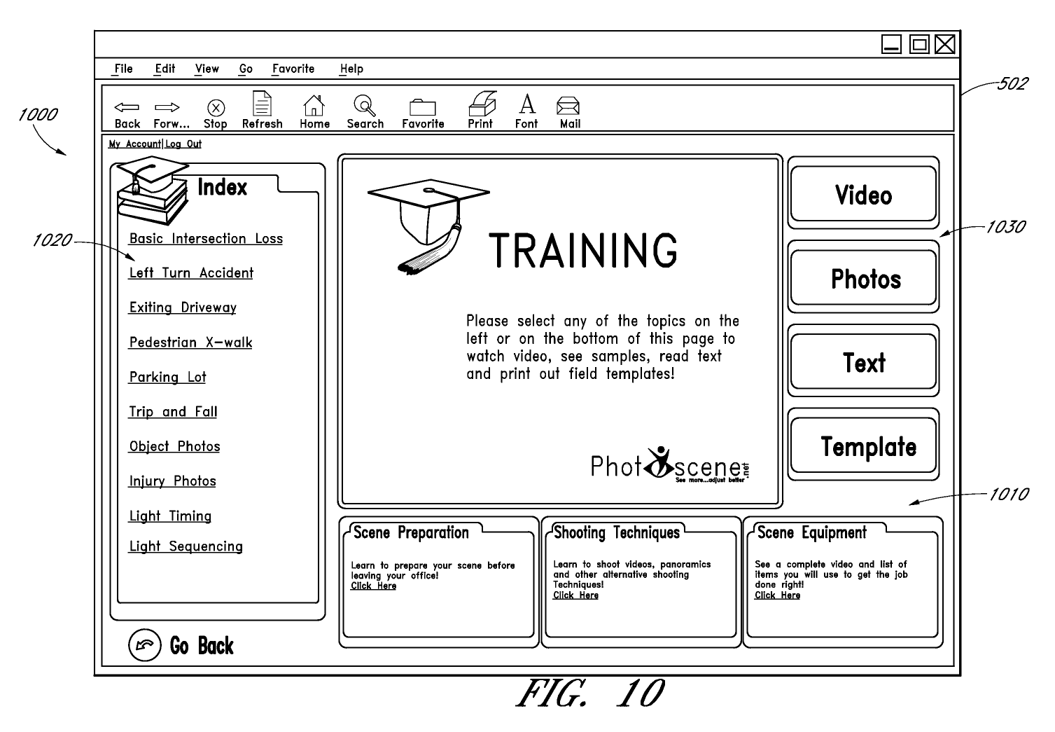

At block 302, a loss reporting network application is provided that has a loss report interface for a user to create a loss report. This block may be implemented by the loss report module 130. The loss reporting network application can be a web site or other type of application, as described above with respect to FIG. 1. Example loss report interfaces are described below with respect to FIGS. 5A through 8. Example loss reports created with such interfaces are described below with respect to FIGS. 9 and 10.

Loss information is received from the user with the loss report interface at block 304. This block may also be implemented by the loss report module 130. This loss information can include loss, user, and/or claim characteristics.

At block 306, one or more advertisements are selected based at least partly on a loss reporting characteristic of the network application and on the loss information. This block may be implemented by the advertising module 150 or 250. For example, by virtue of the network application being related to loss reporting, the one or more advertisements selected in block 306 can be related to losses. Thus, the advertisements may be automatically targeted to users. The one or more advertisements selected may also be further targeted or personalized based at least partly on the loss, user, and/or claim characteristics of the loss information. In other embodiments, one or more advertisements that are unrelated to accidents may be selected.

The one or more advertisements are output for presentation to the user at block 308. This block may also be implemented by the advertising module 150 or 250. The advertisement may be embedded in the loss report interface or in the loss report itself, which may be provided by the loss reporting system 120 as a web page or the like to the user's computer system. In turn, the user's computer system may render the advertisement, e.g., using browser software or the like.

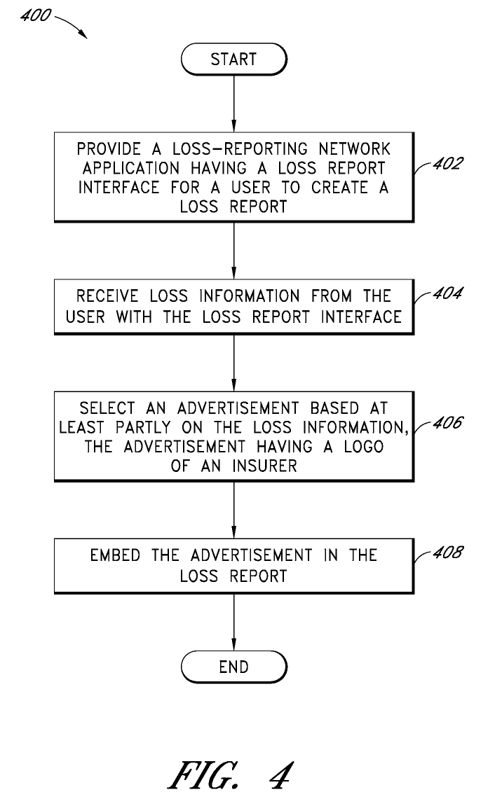

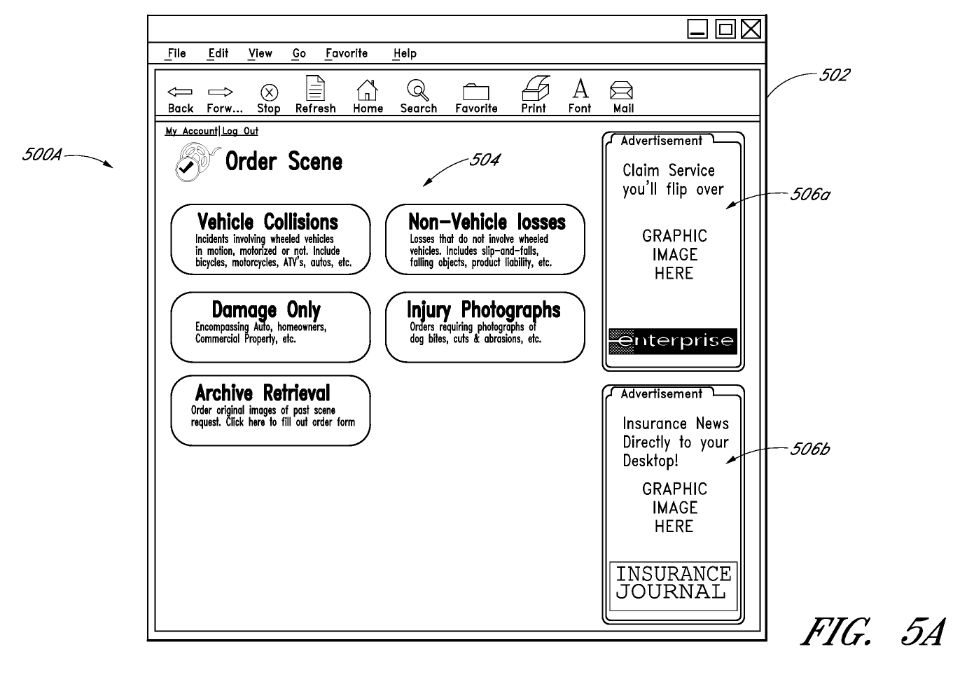

FIG. 4 illustrates an embodiment of an ad embedding process 400 for embedding one or more ads in a loss report. The ad embedding process 400 may be implemented by the loss reporting system 120. Advantageously, in certain embodiments, the ad embedding process 400 selects one or more targeted ads and embeds the ads in a loss report. In one embodiment, the loss reporting system 120 may perform both ad selection process 300 and the ad embedding process 400.

Blocks 402 and 404 may proceed as described above with respect to blocks 302 and 304 of FIG. 3. However, in one embodiment, the user providing loss information to the loss reporting interface is an adjuster, or a technician creating a report on behalf of an adjuster, or any other party. At block 406, an advertisement is selected based at least partly on the loss information provided in connection with the report. This block may be performed by the advertisement module 150 or 250. In the depicted embodiment, the advertisement includes a logo of an insurer or insurance company. The insurance company may be an employer of or be otherwise associated with the adjuster.

The advertisement is embedded in the loss report at block 410. This block may also be performed by the advertisement module 150 or 250. Embedding the advertisement in the loss report may include overlaying an image or video of the loss report with the logo. The logo may also be placed in a document or text associated with the loss report.

Advantageously, in certain embodiments, if the loss report is distributed to other people, those people may view the logo embedded in the loss report. Because they see the logo embedded in the loss report, they may perceive that the insurer is providing high quality services for its clients and decide to request the insurer's services. In other embodiments, any other type of ad, such as a loss-related ad, may be embedded in the loss report.

FIGS. 5A through 8 depict example loss report interfaces. These loss report interfaces are shown as graphical user interfaces in a web browser 502. However, other applications could be used to output the loss report interfaces in other embodiments. Some or all of these interfaces may be used to create a loss report.

Turning to FIG. 5A, an example loss report interface 500A is shown. The loss report interface 500A may be used by a loss participant, an adjuster, or the like to initiate creation of a loss report. The loss report interface 500A may instead be used to request a technician to create a loss report.

The loss report interface 500A includes loss type controls 504. The loss type controls 504 may be user interface controls that enable a user to select a type of loss the user wishes to describe in the report. The loss types controls 504 shown are buttons as an illustrative example. Other types of controls may be used instead, such as radio buttons, check boxes, drop-down lists, text boxes, or the like.

The example controls 504 in the depicted embodiment include several loss types, such as vehicle collisions, non-vehicle losses, general damage, and injuries. The vehicle collisions in certain embodiments can be for incidents involving wheeled vehicles in motion, motorized or not, including cars, bicycles, ATVs, trucks, and the like. Non-vehicle losses can include losses that do not involve wheeled vehicles, such as slip and falls, falling objects, product liability, and the like. General damage losses might include auto, homeowners, commercial property damages, and the like. Injuries may include dog bites, cuts and abrasions, and other injuries. These loss types are illustrative only, and there may be more or fewer or even different loss types in other embodiments.

In one embodiment, selecting one of the loss type controls 504 results in the loss report interface 500A causing a loss report to be ordered. The loss report may then be completed by a technician and uploaded for viewing by the user and/or others. In another embodiment, selecting one of the loss type controls 504 results in the loss report interface 500A directing the user to another loss report interface for entering additional loss information. For example, the user may be directed to an interface such as is described with respect to FIG. 5B below.

Example advertisements 506 are also shown on the loss report interface 500A. These advertisements 506 may have been generated using any of the techniques described above. In the depicted embodiment, the advertisements 506 are targeted toward an adjuster. These ads 506 may have been selected, for example, because the user requesting a loss report is an adjuster. Thus, one of the advertisements 506a is for claim service provided by a rental car company and the other 506b is for an insurance publication. In other embodiments, for example, when the user is a loss participant, advertisements different from those shown may be selected for presentation to the user.

Referring to FIG. 5B, another example loss report interface 500B is shown. The loss report interface 500B may be presented to a user in one embodiment in response to a selection of a loss type control 504 in the loss report interface 500A described above. The loss report interface 500B may also be provided to a user without first presenting the loss report interface 500A. The loss report interface 500B may be used by a loss participant or the like to create a loss report. The same or similar user interface may be used by a technician, adjuster, or other party to create a loss report.

The loss report interface 500B includes media controls 510 for uploading media to the loss report interface 500B. The media controls 510 can be user interface controls that allow a user to upload documents, images, video, audio, and the like to the loss report interface 500B. This media may be then displayed in the loss report interface 500B. Examples of such media include images 520 and video 530 shown in the loss report interface 500B. A text control 540 is also provided with the loss report interface 500B. The text control 540 allows each user to describe the loss via text.

The loss report interface 500B in the depicted embodiment also includes report sharing controls 550. The report sharing controls 550 shown include a text box 552 for entering one or more e-mail or other addresses for intended recipients and a send button 554. Upon selection of the send button 554, the loss report interface 500B can cause an e-mail or other message to be sent to an intended recipient identified by the user in the text box 552. Upon receipt of the message, the intended recipient may access the loss report created by the loss report interface 500B. The message may include a link and/or a code to access the loss report online, or the loss report may be forwarded as an attachment to the message. Users who receive an invitation to review a loss report can collaborate on the report (see FIG. 9).

The report sharing controls 550 in certain embodiments advantageously enable a user to share his or her loss report with insurance adjusters, public adjusters, attorneys, other loss participants, and even friends and family. An insurance adjuster might be able to use the information in the loss report to prepare an insurance claim. Similarly, an attorney may be able to use the information contained in the loss report as evidence in a suit related to the loss. Moreover, a user may use the report sharing controls 550 to initiate a claim. In other embodiments (not shown), the loss report interface 500B may include a separate claim reporting control that enables the user to submit the loss report directly to an insurance company or the like to initiate a claim.

Example advertisements 562, 564 are also shown on the loss report interface 500B. These advertisements 562, 564 may have been generated using any of the techniques described above. In the depicted embodiment, the advertisements 562, 564 are targeted toward a loss participant. These ads 562, 564 may have been selected because the user requesting a loss report is a loss participant. Moreover, the ads 562, 564 are targeted to an automobile accident. Thus, one of the advertisements 562 is for an automobile insurer and the other 564 is for a car rental company. In other embodiments, for example, when the user is an adjuster, advertisements different from those shown may be selected for presentation to the user.

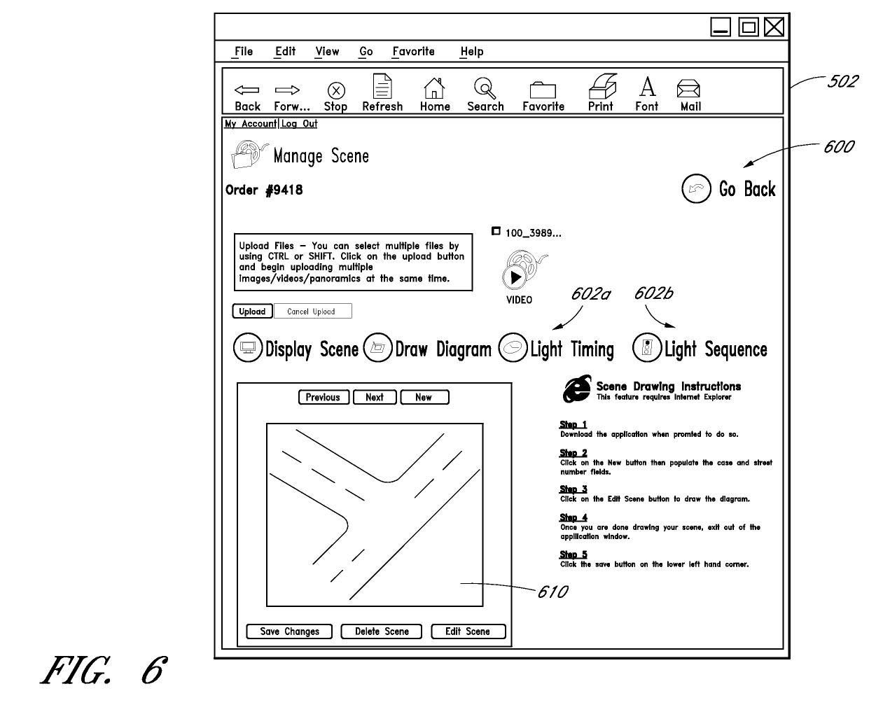

In certain embodiments, the loss report interface 500B may include a link or other option to access additional loss reporting features. Or alternatively, these additional loss reporting features may be provided on the loss reporting interface 500B itself. Examples of these additional loss reporting features are described below with respect to FIGS. 6 through 8.

In FIG. 6, an example drawing loss report interface 600 is shown, which allows a user to create one or more drawings of a loss scene. The drawing loss report interface 600 includes a drawing control 610 that can enable users to sketch street intersections, vehicle placement relative to streets, and the like. For example, the loss report interface 600 may include the “Easy Street Draw” application provided by Trancite Logic Systems. More generally, the drawing control 610 can be used to sketch any loss scene. The resulting drawing(s) may be included in the loss report created by the user (see FIG. 9). Although not shown, ads also may be provided on the drawing loss report interface 600.

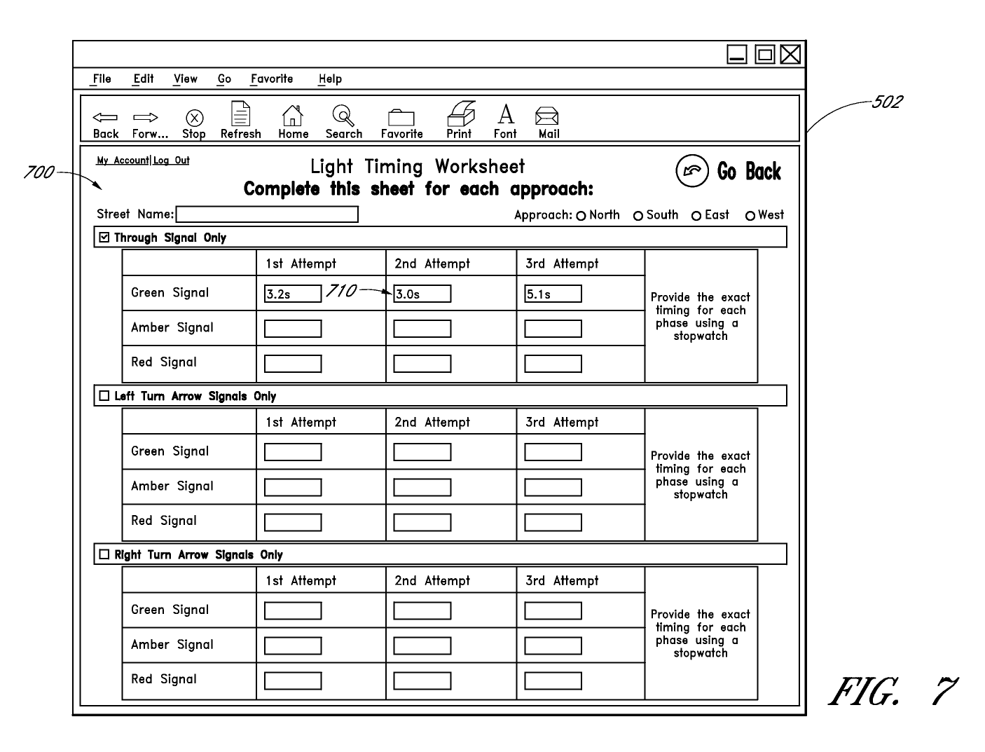

The drawing loss report interface 600 also includes controls 620 for entering traffic light timing and traffic light sequencing information. User selection of the light timing control 620a can result in the loss report module 130 outputting a light timing user interface to the user. Turning to FIG. 7, an example of a light timing loss report interface 700 is shown. The light timing loss report interface 700 includes user interface controls 710 for entering information about light timing, such as the amount of time it takes each color signal to change to a different color. In the depicted embodiment, the user interface controls 710 are text boxes, which hold numerical time values provided by the user. Light timing information may be used by an adjuster to determine, for instance, whether traffic lights could have occurred when a claimant said they occurred. Although not shown, ads also may be provided on the light timing loss report interface 700.

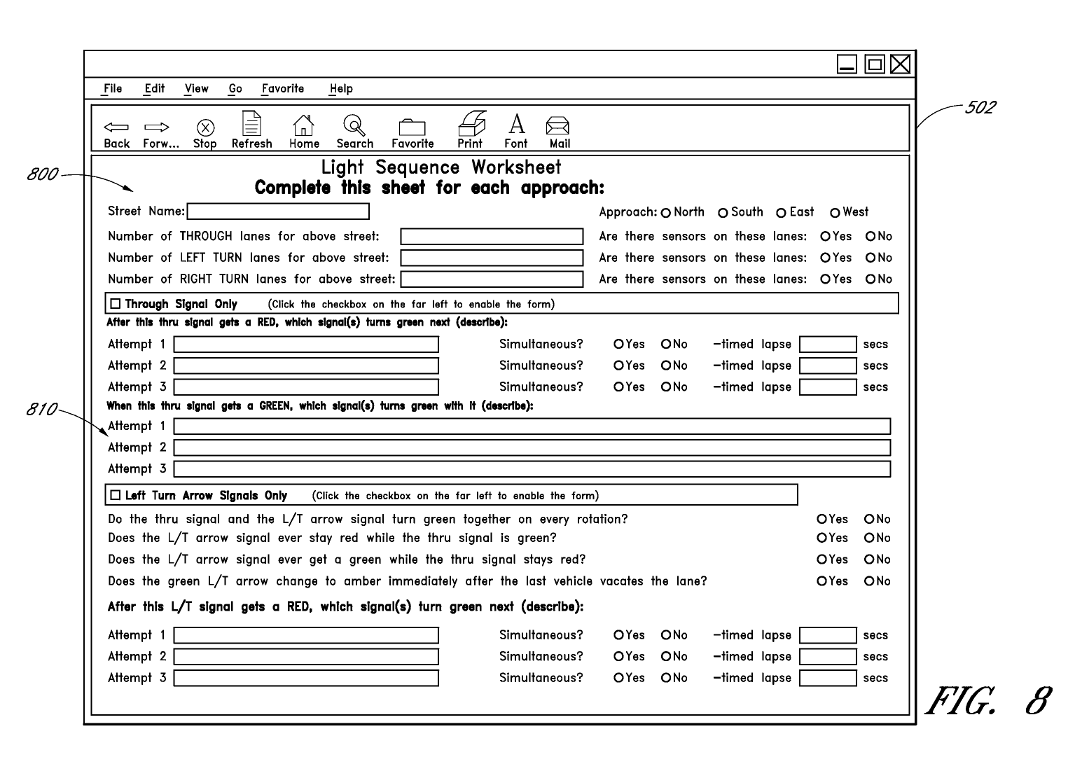

Referring again to FIG. 6, user selection of the light sequencing control 620b can result in the loss report module 130 outputting a light sequence loss report interface to the user. Turning to FIG. 8, an example of a light sequence loss report interface 800 is shown. The interface 800 includes user interface controls 810 for entering information about light sequencing, such as the order in which different light colors occur. In the depicted embodiment, the user interface controls 810 include text boxes and radio buttons for entering the order of lights according to a particular approach (e.g., north, south, east, or west), whether sensors are present on lanes, and so forth. Light sequence information may be used by an adjuster to determine, for instance, whether traffic lights occurred as a claimant said they occurred. Although not shown, ads also may be provided on the light sequence loss report interface 800.

FIG. 9 depicts an example loss report 900. The loss report 900 can be generated by the loss reporting system 120 described above. In particular, in one embodiment, the loss report 900 may be generated by a user using the loss report module 130 and one or more of the user interfaces such as the loss reporting interfaces of FIGS. 5A through 8. The loss report 900 is an example of a report that might have been created by a loss participant. Reports created by adjusters, technicians, or others may appear the same or similar.

The loss report 900 includes scene information 910. The scene information 910 includes, in the depicted embodiment, biographical information about an insured and a claimant, the location of the loss, and the date of the loss, and a claim number. Scene notes 912 are also provided, which may have been generated by the text control 540 described above (see FIG. 5B). Likewise, video 920 and images 924 are provided. Moreover, additional features 930 shown include links to panoramic photographs, a street diagram, traffic light timing, and traffic light sequencing. Fewer than all of these features may be present with certain loss reports, depending on which features are ordered or created by a user.

The loss report 914 also includes an adjuster notepad 914. The adjuster notepad 914 may be displayed if an adjuster (e.g., a user with an adjuster profile) is accessing the loss report 900. A notepad may also be displayed for other users. The adjuster notepad allows the adjuster to contribute notes about the loss, which may be saved with the loss report 900. In addition, although not shown, in certain embodiments the adjuster may also be able to attach additional media to the loss report. Likewise, the adjuster may be able to order or use the additional features 930. Thus, an adjuster or other party can collaborate with the creator of the report to change the content of the report.

The loss report 900 also includes report sharing controls 950, similar to the report sharing controls 550 described above with respect to FIGURE 5B. The report sharing controls 550 allow a viewer of the report to invite other users to view and/or collaborate with the report.

Although not shown, the loss report 900 may also display ads that are targeted to the viewer of the loss report, which may be generated, for example, as described above.

FIG. 10 illustrates an example training user interface 1000 for training users to create loss reports. The training user interface 1000 can be generated by the loss reporting system 120 described above. In particular, in one embodiment, the training user interface 1000 may be generated by the training module 140. The training user interface 1000, in various implementations, can provide users with training in creating loss reports. While the training user interface 1000 is shown as graphical user interface in a web browser 1002, other applications could be used to output the training user interface 1000 in other embodiments.

The training user interface 1000 includes features for training users to create loss reports. Advantageously, in certain embodiments, the training user interface 1000 may train users to create loss reports that have information useful to insurance claim adjusters. For instance, the training user interface 1000 includes instruction controls 1010 for instructing users in loss report (e.g., scene) preparation, camera and video shooting techniques, and equipment useful for gathering loss information. The training user interface 1000 also includes loss topics 1020 for training users in what information is useful to gather for a particular loss. Example loss topics 1020 shown include “basic intersection loss,” “left turn accident,” “trip and fall,” “light timing,” and others. The training user interface 1000 can provide options 1030 for accessing video, photo, text, and templates associated with one or more of the loss topics 1020.

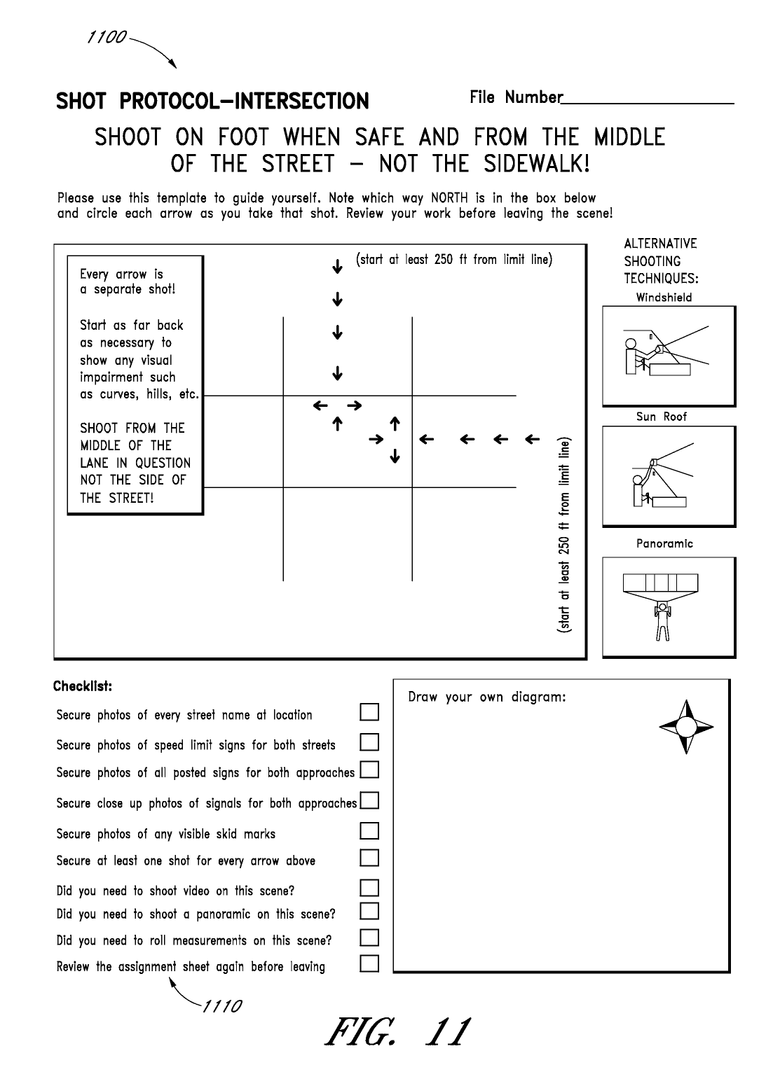

FIG. 11 illustrates an example template 1100 for training users to create loss reports. The template 1100 includes instructional material for training a user to photograph a loss at an intersection. The template 1100 may be accessed, for example, from the options 1030 displayed on the example training user interface 1000 of FIG. 10. The template 1100 includes a checklist 1110 which advises a user on steps to take when shooting an intersection. In some embodiments, the checklist may be electronic, and the user can use the electronic checklist to keep track of which steps the user has completed.

In sum, the various illustrative logical blocks, modules, and processes described herein may be implemented as electronic hardware, computer software, or combinations of both. To clearly illustrate this interchangeability of hardware and software, various illustrative components, blocks, modules, and states have been described above generally in terms of their functionality. However, while the various modules are illustrated separately, they may share some or all of the same underlying logic or code. Certain of the logical blocks, modules, and processes described herein may instead be implemented monolithically.

The various illustrative logical blocks, modules, and processes described herein may be implemented or performed by a machine, such as a computer, a processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, a controller, microcontroller, state machine, combinations of the same, or the like. A processor may also be implemented as a combination of computing devices, e.g., a combination of a DSP and a microprocessor, a plurality of microprocessors or processor cores, one or more graphics or stream processors, one or more microprocessors in conjunction with a DSP, or any other such configuration.

The blocks or states of the processes described herein may be embodied directly in hardware, in a software module executed by a processor, or in a combination of the two. For example, each of the processes described above may also be embodied in, and fully automated by, software modules executed by one or more machines such as computers or computer processors. A module may reside in a computer-readable storage medium such as RAM memory, flash memory, ROM memory, EPROM memory, EEPROM memory, registers, hard disk, a removable disk, a CD-ROM, memory capable of storing firmware, or any other form of computer-readable storage medium known in the art. An example computer-readable storage medium can be coupled to a processor such that the processor can read information from, and write information to, the computer-readable storage medium. In the alternative, the computer-readable storage medium may be integral to the processor. The processor and the computer-readable storage medium may reside in an ASIC.

Depending on the embodiment, certain acts, events, or functions of any of the processes or algorithms described herein can be performed in a different sequence, may be added, merged, or left out all together. Thus, in certain embodiments, not all described acts or events are necessary for the practice of the processes. Moreover, in certain embodiments, acts or events may be performed concurrently, e.g., through multi-threaded processing, interrupt processing, or via multiple processors or processor cores, rather than sequentially.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the logical blocks, modules, and processes illustrated may be made without departing from the spirit of the disclosure. As will be recognized, certain embodiments of the inventions described herein may be embodied within a form that does not provide all of the features and benefits set forth herein, as some features may be used or practiced separately from others. The scope of certain inventions disclosed herein is indicated by the claims rather than by the foregoing description. All changes which come within the meaning and range of equivalency of the claims are to be embraced within their scope.

1. A server system for offering targeted advertisements in connection with a loss report, the server system comprising:
a loss reporting system comprising a loss report module and an advertising module, the loss report module operative to:
output a loss report interface for presentation to a user, the loss report interface configured to provide functionality for the user to create a loss report by inputting data corresponding to a loss, the loss data comprising one or more of at least one image, at least one video, and text, and
provide functionality for the user to electronically submit the loss report to one or more entities, the one or more entities comprising one or more of the following: a claim adjuster, an insurer, and an attorney; and
the advertising module comprising computer hardware, the advertising module comprising:
a loss data mining module configured to analyze the loss data to determine one or more of a characteristic of the loss and a characteristic of the user, and
an advertisement selector configured to obtain a loss-related advertisement based at least partly on a loss-reporting attribute of the loss reporting system and on one or more of the loss characteristic and the user characteristic, such that the advertisement is for an item that corresponds to one or more effects of the loss.

2. The server system of claim 1, wherein the user characteristic comprises a type of the user, and wherein the advertisement selector is further configured to select the advertisement based at least partly on the user type.

3. The server system of claim 1, wherein the user characteristic comprises a geographic location associated with the user, and wherein the advertisement selector is further configured to select the advertisement based at least partly on the geographic location.

4. The server system of claim 1, wherein the loss characteristic comprises a type of the loss, and wherein the advertisement selector is further configured to select the advertisement based at least partly on the loss type.

5. The server system of claim 1, wherein the loss characteristic comprises a severity of the loss, and wherein the advertisement selector is further configured to select the advertisement based at least partly on the loss severity.

6. The server system of claim 1, wherein the item comprises a service.

7. The server system of claim 1, wherein the advertisement selector is further configured to obtain the loss-related advertisement based on a claim characteristic.

8. A computer-readable storage medium having instructions stored thereon that cause one or more processors to perform a method of offering targeted advertisements in connection with a loss report, the method comprising:
outputting one or more loss report interfaces using a network application for presentation to a user, the one or more loss report interfaces configured to provide functionality for the user to create a loss report by inputting data corresponding to a loss, the loss data comprising one or more of at least one image, at least one video, and text;
providing functionality for the user to electronically submit the loss report to one or more entities, the one or more entities comprising one or more of the following: a claim adjuster, an insurer, and an attorney; and
using one or more processors to obtain a loss-related advertisement based at least partly on a loss-reporting attribute of the network application and on one or more of loss, user, and claim information mined from the loss data, such that the advertisement is for an item that corresponds to one or more effects of the loss.

9. The computer-readable storage medium of claim 8, wherein the method further comprises providing functionality for the user to submit an insurance claim comprising the loss report.

10. The computer-readable storage medium of claim 8, wherein said using one or more processors to obtain a loss-related advertisement comprises obtaining the loss-related advertisement based at least partly on a type of the loss.

11. The computer-readable storage medium of claim 8, wherein said using one or more processors to obtain a loss-related advertisement comprises obtaining the loss-related advertisement based at least partly on a user type of the user.

12. The computer-readable storage medium of claim 8, wherein said using one or more processors to obtain a loss-related advertisement comprises obtaining the loss-related advertisement based at least partly on a stage of a claim.

13. A processor-implemented method of advertising insurance, the method comprising:
providing a loss-reporting network application comprising a loss report interface, the loss report interface configured to provide functionality for a user to create a loss report by inputting data corresponding to a loss, the loss data comprising one or more of at least one image, at least one video, and text;
receiving an indication of a type of the loss;
using one or more processors to select an advertisement based at least partly on the type of the loss, the advertisement comprising a logo of an insurer that provides insurance for the loss type; and
automatically embedding the advertisement in the loss data.

14. The method of claim 13, wherein said using one or more processors to select the advertisement further comprises selecting the advertisement based at least partly on a loss-reporting attribute of the network application.

15. The method of claim 13, wherein the user is a claim adjuster.

16. The method of claim 13, wherein said automatically embedding the advertisement in the loss data comprises inserting the advertisement in the at least one image.

17. A loss reporting system, the loss reporting system comprising:
a loss report module operative to output a loss report interface for presentation to a user, the loss report interface configured to provide functionality for the user to prepare a loss report by inputting loss data corresponding to a loss;
a training module operative to electronically provide instructions for preparing the loss report to the user, such that the loss report includes information relevant to an insurance claim; and
an advertising module comprising computer hardware, the advertising module configured to use loss information to obtain an advertisement targeted to the user, the advertisement being for an item that corresponds to one or more effects of the loss.

18. The loss reporting system of claim 17, wherein the training module is further operative to provide traffic light timing instructions.

19. The loss reporting system of claim 17, wherein the training module is further operative to provide traffic light sequencing instructions.

20. The loss reporting system of claim 17, wherein the loss report comprises functionality for the one or more entities to collaborate on the loss report.

21. The loss reporting system of claim 17, wherein the advertising module is further configured to obtain the advertisement based at least in part on one or more of loss, user, and claim characteristics derived from the loss information.

22. The computer-readable storage medium of claim 8, further comprising providing functionality for the user to email the loss report to other users and marketing one or more advertisements to the other users who receive the loss report.

23. The method of claim 13, wherein the advertisement comprises the logo of the user's insurer.
